(19) United States
(12) Patent Application Publication
(10) Pub. No.: US 2020/0063766 A1
(43) Pub. Date: Feb. 27, 2020

(54) ADJUSTABLE PASSIVE CHOKES

(71) Applicant: Secure Energy (Drilling Services) Inc., Calgary (CA)

(72) Inventors: Evan STEPHENS, Lloydminster (CA); Ryan STASIUK, Lloydminster (CA); Ahmed ALJUBORI, Calgary (CA)

(73) Assignee: Secure Energy (Drilling Services) Inc., Calgary, AB (CA)

(21) Appl. No.: 16/488,536

(22) PCT Filed: Jan. 31, 2018
(86) PCT No.: PCT/CA2018/050111

§ 371 Date: Aug. 23, 2019

(30) Foreign Application Priority Data
Feb. 24, 2017 (CA) 2,958,979

(51) Int. Cl. F15D 1/02; F15D 1/14; E21B 34/02; E21B 43/20; E21B 47/06

(52) U.S. Cl. CPC F15D 1/025; F15D 1/14; E21B 47/06; E21B 43/20; E21B 34/02

(57) ABSTRACT

Adjustable passive choke devices, systems, and methods for controlling fluid flow rate, pressure, or both, are provided. The adjustable passive choke devices may comprise a fluid conduit having a first end, a second end, and an intervening portion therebetween, the intervening portion comprising a flow resistance element for reducing a flow rate of a fluid when the fluid is passed through the fluid conduit from the first end to the second end. The devices may further comprise a selectable bypass line connected upstream and downstream of the flow resistance element, or a portion thereof, operable to provide a fluid flow bypass path bypassing all, or a portion, of the flow resistance element when activated.

### RELATED APPLICATIONS

This PCT application claims priority to Canadian patent application 2,958,979 filed Feb. 24, 2017, the contents of which are hereby incorporated in their entirety.

### FIELD OF INVENTION

The present invention relates generally to devices and methods for controlling flow rate and/or pressure. More specifically, the present invention relates to adjustable passive choke devices for controlling flow rate and/or pressure within a system.

### BACKGROUND

Passive choke devices are commonly used in many industrial processes and systems to control or regulate flow rate. Passive chokes typically include one or more elements or structures which resist, or choke, the flow of fluid when passed therethrough. As a result, the inclusion of a passive choke device within a pipeline or other fluid transport system allows for the fluid flow rate within the system to be reduced, thereby providing a measure of control over fluid flow rate. Passive choke devices are typically designed to avoid excessive energy requirements and/or constant upkeep, and instead provide for flow reduction using passive design elements such as flow restricting sections, loops or coils, bends, narrowed sections, or other flow path modifying designs which reduce fluid flow rate via frictional line loss and/or backpressure.

Passive choke devices have proven particularly useful in systems involving a common line or feed line, which provides fluid to two or more fluid distribution lines having differing backpressure or other characteristics affecting flow rate. By way of example, chemical enhanced oil recovery (EOR) operations typically involve two or more polymer injection wells (i.e. fluid distribution lines) which are fed polymer by a common line. As each individual injection well may be injecting polymer into deposits having different depths, access paths, and/or backpressures, situations are commonly encountered where fluid flows more readily through one injection well as compared with another. In such conditions, polymer from the common line will become unevenly distributed, with an increased proportion being diverted to the injection well(s) having the least resistance to fluid flow.

Such unequal fluid distribution profiles are frequently corrected in oilfield operations using a form of passive choke device known as a coil choke. Coil chokes typically comprise a fluid conduit which is coiled or looped, such that fluid flowing through the fluid conduit navigates one or a plurality of coils, which have the effect of increasing fluid flow path length, and reducing fluid flow rate via frictional line loss. A coil choke will commonly include a plurality of in-line coils, which have an additive effect on reducing flow rate through the fluid conduit. An oilfield operator will commonly install a coil choke on injection well(s) of the system having the least resistance to fluid flow in an effort to equalize fluid flow rates between the different injection wells, thereby allowing for substantially equal polymer distribution assuming flow characteristics remain constant between the injection wells.

In the oil and gas industry, operators will typically determine which injection wells are in need of decreased fluid flow rate so as to equalize the system, and then install coil chokes on these injection wells to reduce fluid flow rate therethrough. As the amount of fluid flow resistance needed will vary between injection wells, operators typically manually cut, splice, or remove sections (i.e. remove coils, or portions thereof) from the coil choke until the device provides the proper amount of fluid flow resistance to meet the demands of the particular injection well being corrected. As the flow characteristics of an injection well can change over time, manual adjustments to installed coil chokes may be needed in an ongoing fashion, increasing costs and operational downtime.

An alternative, additional, and/or improved passive choke device for controlling flow rate is desirable.

### SUMMARY OF INVENTION

Provided herein are adjustable passive choke devices comprising a selectable bypass line operable to provide a fluid flow bypass path bypassing all, or a portion, of a flow resistance element when activated. Certain embodiments of such devices may allow for adjustment of the fluid flow resistance properties of the passive choke without the need for time-consuming manual cutting/splicing operations. Rather, control over fluid flow rate and/or pressure may be realized by activating, or deactivating, the selectable bypass line as needed to suit the flow rate demands of the particular system. Operation of devices, as provided herein, may even be automated, further reducing operational demands on an ongoing basis.

In an embodiment, there is provided herein an adjustable passive choke device for controlling fluid flow rate and/or pressure, said device comprising:
a fluid conduit having a first end, a second end, and an intervening portion therebetween, the intervening portion comprising a flow resistance element for reducing a flow rate of a fluid when the fluid is passed through the fluid conduit from the first end to the second end; and
a selectable bypass line connected upstream and downstream of the flow resistance element, or a portion thereof, operable to provide a fluid flow bypass path bypassing all, or a portion, of the flow resistance element when activated;

whereby activation of the selectable bypass line configures the adjustable passive choke device for increased flow rate by at least partially opening the fluid flow bypass path, and deactivation of the selectable bypass line configures the adjustable passive choke device for decreased flow rate by at least partially closing the fluid flow bypass path.

In another embodiment of the above device, the selectable bypass line may comprise two or more upstream connections, downstream connections, or both, so as to provide a plurality of selectable fluid flow bypass paths, each bypassing a different proportion of the flow resistance element.

In still another embodiment of the above device or devices, the flow resistance element may comprise one or more loops or coils for reducing fluid flow rate by frictional line loss.

In yet another embodiment of the above device or devices, fluid flow through the selectable bypass line may be controlled by one or more valves.

In another embodiment of the above device or devices, the device may further comprise a flow meter downstream of the flow resistance element for determining fluid flow rate.

In another embodiment of the above device or devices, the device may further comprise one or more pressure gauges or pressure sensors for determining pressure downstream of the device.

In still another embodiment of the above device or devices, the device may further comprise one or more pressure gauges or pressure sensors for determining a pressure drop (A pressure/length) across the flow resistance element or one or more portions thereof.

In yet another embodiment of the above device or devices, fluid flow through the selectable bypass line may be controlled by a programmable logic controller (PLC).

In still another embodiment of the above device or devices, activation and deactivation of the selectable bypass line, and selection of the fluid flow bypass path where the selectable bypass line includes more than one fluid flow bypass path, may be automated, such that flow rate, downstream pressure, or both, are maintained at predetermined value(s), above predetermined lower limit(s), below predetermined upper limit(s), or within predetermined range(s).

In yet another embodiment of the above device or devices, activation and deactivation of the selectable bypass line, and selection of the fluid flow bypass path where the selectable bypass line includes more than one fluid flow bypass path, may be determined at least in part by a measured flow rate parameter, a measured pressure drop parameter, a measured downstream pressure parameter, or any combination thereof.

In still another embodiment of the above device or devices, the device may comprise two or more flow resistance elements.

In another embodiment of the above device or devices, the flow resistance elements may each provide the same, or different, resistance to fluid flow therethrough.

In yet another embodiment of the above device or devices, the selectable bypass line may be operable to provide one or more fluid flow bypass paths bypassing all, or a portion, of the two or more flow resistance elements.

In still another embodiment of the above device or devices, the device may comprise two or more individually selectable bypass lines which are each operable to provide different fluid flow bypass paths when activated.

In another embodiment of the above device or devices, the adjustable passive choke device may be for controlling flow rate and/or downstream pressure through an injection well in an oil recovery operation, or through an industrial water injection operation.

In yet another embodiment of the above device or devices, the flow resistance element may be structured with a 2× multiplier configuration providing incremental doubling of length and/or flow resistance between portions of the flow resistance element.

In another embodiment, there is provided herein a fluid transport system comprising:
one, two or more fluid distribution lines;
a common line for supplying a fluid to the one two or more fluid distribution lines;
a pump for supplying the fluid to the common line, and
at least one of the above adjustable passive choke device or devices positioned before or within at least one of the fluid distribution lines for controlling flow rate therethrough and/or pressure downstream thereof.

In another embodiment of the above system, operation of the one or more adjustable passive choke devices may be controlled by a programmable logic controller (PLC).

In still another embodiment of the above system or systems, the one or more adjustable passive choke devices may control flow rate such that fluid flow rate through two or more of the fluid distribution lines is substantially equal, or such that fluid flow rate between the two or more fluid distribution lines is maintained at a predetermined ratio, above a predetermined lower ratio limit, below a predetermined upper ratio limit, or within a predetermined ratio range.

In yet another embodiment of the above system or systems, the one or more adjustable passive choke devices may adapt to changes in fluid flow resistance in the fluid distribution lines such that flow rate and/or pressure through the fluid distribution lines remains substantially constant, or within predetermined range(s).

In still another embodiment of the above system or systems, the fluid distribution lines may be injection wells in an oil recovery operation, or in water injection operations.

In another embodiment, there is provided herein a method for controlling a flow rate and/or pressure of a fluid through a fluid distribution line, said method comprising:
reducing the fluid flow rate by passing the fluid through a flow resistance element; and
increasing the fluid flow rate by passing the fluid through a fluid flow bypass path which bypasses all, or a portion, of the flow resistance element;

as needed so as to maintain the flow rate, the pressure, or both, of the fluid through the fluid distribution line at predetermined value(s), above predetermined lower limit(s), below predetermined upper limit(s), or within predetermined range(s).

In another embodiment of the above method, the method may be performed by operating one or more of the adjustable passive choke device or devices above.

In still another embodiment of the above method or methods, the method may be an automated method performed by a programmable logic controller (PLC).

In yet another embodiment of the above method or methods, the fluid distribution line may be an injection well of an oil recovery operation, or of a water injection operation.

### BRIEF DESCRIPTION OF DRAWINGS

FIG. 1 shows a schematic of one embodiment illustrative of an adjustable passive choke device for controlling fluid flow rate and/or pressure as described herein. The illustrated embodiment is a coil choke-type passive choke, which is installed at an injection well head in an oilfield operation. The illustrated device is for regulating fluid flow rate from a common (supply) line to the injection well under the optionally automated control of a programmable logic controller (PLC) configured to maintain flow rate within a pre-determined flow rate range as measured at a flow meter located downstream of the coil portion of the coil choke by operating valves controlling fluid flow through fluid flow bypass paths provided by selectable bypass lines of the adjustable passive choke device.

### DETAILED DESCRIPTION

Described herein are adjustable passive choke devices, systems, and methods for controlling fluid flow rate and/or pressure. It will be appreciated that embodiments and examples are provided for illustrative purposes intended for those skilled in the art, and are not meant to be limiting in any way.

In one embodiment, there is provided herein an adjustable passive choke device for controlling fluid flow rate, said device comprising:
a fluid conduit having a first end, a second end, and an intervening portion therebetween, the intervening portion comprising a flow resistance element for reducing a flow rate of a fluid when the fluid is passed through the fluid conduit from the first end to the second end; and
a selectable bypass line connected upstream and downstream of the flow resistance element, or a portion thereof, operable to provide a fluid flow bypass path bypassing all, or a portion, of the flow resistance element when activated;

whereby activation of the selectable bypass line configures the adjustable passive choke device for increased flow rate by at least partially opening the fluid flow bypass path, and deactivation of the selectable bypass line configures the adjustable passive choke device for decreased flow rate by at least partially closing the fluid flow bypass path.

As will be understood, the fluid conduit may be any suitable fluid channel, line, conduit, or other structure capable of transporting a fluid such as a liquid, gas, or combination thereof. Suitable fluid conduits may include, for example, a pipe, hose, tube, or other such structure. Fluid conduits will typically include an outer wall defining an internal passage through which a fluid may pass.

As will also be understood, a flow resistance element may be any suitable structure or component for reducing a flow rate of a fluid passing therethrough. Suitable flow resistance elements may include, for example, flow restricting sections, loops or coils, bends, narrowed sections, turbulence-inducing structures, or other flow path modifying designs which reduce fluid flow rate via frictional line loss and/or increased backpressure, for example. In coil choke-type embodiments, a suitable flow resistance element may comprise, for example, a plurality of in-line coils or loops, each of which provides an additive-type flow resistance via frictional line loss such that fluid flow rate is increasingly reduced with each sequential coil or loop traversed. The skilled person having regard to the teachings of the instant application will be aware of several flow resistance element options, and will be able to select a suitable flow resistance element to suit a particular application.

In certain embodiments, it will be understood that suitable flow resistance elements may include those comprising, for example, a plurality of flow restricting sections, loops or coils, bends, narrowed sections, turbulence-inducing structures, or other flow path modifying designs which reduce fluid flow rate via frictional line loss, which may be arranged in series, each providing an additive-type flow resistance via frictional line loss. The flow resistance contribution from each individual member of the plurality may be substantially the same or similar, or may differ between members. By way of example, in coil choke-type embodiments, suitable flow resistance elements may include those comprising a plurality of coils or loops arranged in series, each providing an additive-type flow resistance via frictional line loss. The plurality of coils or loops may each be the same or similar in length, or may have differing lengths.

In certain embodiments, flow resistance elements may include those comprising, for example, a plurality of flow restricting sections, loops or coils, bends, narrowed sections, turbulence-inducing structures, or other flow path modifying designs which reduce fluid flow rate, each providing an additive-type flow resistance, whereby the individual members of the plurality are selected so as to co-operate with one another to provide a flow resistance which is highly adjustable through selection of active bypass line(s). In certain embodiments, a 2× multiplier, for example, may be used for selecting such a co-operative plurality of members.

By way of a further example, in coil choke-type embodiments, suitable flow resistance elements may include those comprising a plurality of coils or loops arranged in series, each providing an additive-type flow resistance via frictional line loss. In certain examples, the plurality of coils or loops may be designed using a 2× multiplier. In such examples, the plurality of coils or loops may comprise a set of coils or loops which incrementally double in length between members of the set (i.e. the coil or loop members of the set may have lengths of n, 2(n), 4(n), 8(n), 16(n), 32(n), etc . . . , wherein n is the length of the shortest member in the set). By way of illustrative example, the flow resistance element may be a coil choke-type flow resistance element comprising a set of coils having lengths of 1 m, 2 m, 4 m, 8 m, and 16 m, respectively. If an individually selectable bypass line is connected upstream and downstream of each coil of the set so as to provide a fluid flow bypass path bypassing each individual coil of the set when activated, then such an adjustable passive choke device may be configured to provide 1 m, 2 m, 3 m, 4 m, 5 m, 6 m, 7 m, 8 m, 9 m, 10 m, 11 m, 12 m, 13 m, 14 m, 15 m, 16 m, 17 m, 18 m, 19 m, 20 m, 21 m, 22 m, 23 m, 24 m, 25 m, 26 m, 27 m, 28 m, 29 m, 30 m, or 31 m of flow resistance coil length as desired. Such devices thus may provide highly adjustable flow resistance, allowing fine adjustment of flow rate by controlling which individually selectable bypass lines are active/inactive.

In the example above, the plurality of coils or loops implement a 2× multiplier by incrementally doubling in length. It will be understood, however, that other configurations implementing a 2× multiplier may also be possible. For example, the plurality of coils or loops may comprise a plurality of coil or loop subsets, where the number of coils or loops in each subset incrementally doubles in number between subsets (i.e., the plurality of coils or loops may comprise a subset having n coil(s) or loop(s), a subset having 2(n) coils or loops, a subset having 4(n) coils or loops, a subset having 8(n) coils or loops, a subset having 16(n) coils or loops, a subset having 32(n) coils or loops, etc . . . , wherein n is the number of coil(s) or loop(s) in the smallest subset). By way of a further illustrative example, the flow resistance element may be a coil choke-type flow resistance element comprising a plurality of coil subsets having 1, 2, 4, 8, and 16 coils, respectively. If an individually selectable bypass line is connected upstream and downstream of each subset so as to provide a fluid flow bypass path bypassing each individual subset of the plurality when activated, then such an adjustable passive choke device may be configured to provide 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, or 31 coils providing flow resistance, as desired. Such devices thus may provide highly adjustable flow resistance, allowing fine adjustment of flow rate by controlling which individually selectable bypass lines are active/inactive. An example of an adjustable passive choke device comprising a plurality of coils which are the same or similar to one another, arranged as subsets implementing a 2× multiplier, is described in further detail in Example 1 below.

As will be understood, a 2× multiplier as described herein may be implemented in a number of ways. Doubling of length and doubling in number are described above. It is also contemplated that a 2× multiplier may be implemented using combinations of length and number manipulation, or using any other suitable design or combination of designs affecting flow resistance as will be known to the person of skill in the art having regard to the teachings provided herein. 2× multiplier implementation may include, for example, any suitable design in which the flow resistance element may be configured to provide flow resistance which is highly adjustable via controlling the activation/deactivation state(s) of individually selectable bypass line(s) providing fluid flow bypass path(s) bypassing portions of the flow resistance element, the portions each having an additive fluid flow resistance contribution which incrementally doubles between portions.

Selectable bypass lines may include any suitable bypass line which is operable to provide a fluid flow bypass path for fluid which bypasses all, or a portion, of the flow resistance element when activated. By bypassing all, or a portion, of the flow resistance element, fluid passing through the fluid flow bypass path provided by the selectable bypass line experiences decreased flow resistance, and therefore activation of the selectable bypass line configures the adjustable passive choke device for increased flow rate. In contrast, deactivation of the selectable bypass line at least partially closes the fluid flow bypass path, causing fluid to pass through the flow resistance element and experience increased flow resistance, configuring the adjustable passive choke device for increased flow rate.

It will be recognized that selectable bypass lines may comprise any suitable fluid channel, line, conduit, or other structure capable of forming at least one continuous fluid flow bypass path when activated. Suitable selectable bypass lines may include those comprising a pipe, hose, tube, or other such structure, for example. Selectable bypass lines will typically include an outer wall defining an internal passage through which a fluid may pass.

As will be understood, in certain embodiments, the selectable bypass line may be connected or located upstream and downstream of the flow resistance element, or a portion thereof. In certain embodiments, the selectable bypass line may comprise one, two, or more upstream connections; one, two, or more downstream connections; or both; so as to provide a plurality of selectable fluid flow bypass paths, each bypassing a different proportion or section of the flow resistance element.

By way of illustrative example, an adjustable passive choke device as described herein may include a flow resistance element comprising a plurality of coils. In such an embodiment, the selectable bypass line of the adjustable passive choke device may comprise a plurality of upstream connections positioned before each of the coils, and a downstream connection positioned after the last coil. Such configuration would allow the selectable bypass line to be operable to provide a plurality of fluid flow bypass options, each bypassing a different number of coils of the flow resistance element. By choosing which upstream connection is operable when the selectable bypass line is activated, the flow resistance provided by the adjustable passive choke device can be adjusted as desired by allowing fluid to bypass all, or a portion, of the coils of the flow resistance element.

As will also be understood by the person of skill in the art having regard to the teachings herein, activation and deactivation of the selectable bypass line, and accompanying flow of fluid through the flow resistance element, the fluid flow bypass path provided by the selectable bypass line, or both, may be controlled using any suitable fluid flow control mechanism known to the person of skill in the art. By way of example, fluid flow through the adjustable passive choke device may be directed by valves, switches, apertures, or other suitable fluid-directing mechanisms. In certain embodiments, fluid flow may be controlled by one or more valves (for example, solenoid valves) controlling fluid flow through the flow resistance element, the fluid flow bypass path provided by the selectable bypass line, or both. Exemplary valves may be those which direct fluid to either the flow restriction element or the fluid flow bypass path, or may be those which are capable of directing a portion of the fluid to the flow restriction element, and another portion to the fluid flow bypass path. By varying the proportion of fluid flowing to the flow restriction element versus the fluid flow bypass path, for example, the flow resistance provided by the adjustable passive choke device may be varied to meet changing flow resistance demands in a system.

In certain further embodiments, adjustable passive choke devices as described herein may include, or may interface with, one or more flow meters and/or pressure gauges/sensors, optionally located downstream of the flow resistance element, for determining fluid flow rate and/or downstream pressure. The skilled person will be aware of a variety of suitable flow meters, pressure gauges, and pressure sensors, and will be able to select suitable meter(s), gauge(s), or sensor(s) to suit a particular application. Such flow meters may provide a flow rate read-out allowing for assessment of flow through the system and, if desired, adjustment of the adjustable passive choke device to increase or decrease flow resistance in accordance with the flow rate demands of the particular system. Such pressure gauges or sensors may provide a downstream pressure read-out allowing for assessment of pressure in the system and, if desired, adjustment of the adjustable passive choke device to increase or decrease flow resistance in accordance with the pressure demands of the particular system.

In certain embodiments where a coil choke-type design is used, the pressure drop across the coils (i.e. (A pressure)/(length)) may be determined and used in designing and/or controlling the flow resistance element. Typically, pressure and/or A pressure will be a site specific metric, and the design may be adapted for the specific site metrics as will be appreciated by the person of skill in the art in view of the teachings herein. For example, viscosity, flow rate, and/or pressure differential (i.e. pressure differential desired between different fluid distribution lines) factors of a given system may be considered when selecting coil length and diameter, such that pressure drop across the coils (i.e. (Δ pressure)/(length)) is appropriate for the particular application. As well, knowing the pressure drop across the coils (i.e. (Δ pressure)/(length)), and/or monitoring the pressure drop across the coils (i.e. (Δ pressure)/(length)) on an ongoing basis, may be used to inform control over activation/deactivation of the selectable bypass line(s) of adjustable passive choke devices so as to assist in maintaining a desired flow rate in the system. One or more pressure gauges and/or other gauges or sensors may be used for determining pressure drop across the coils (i.e. (Δ pressure)/(length)), for example.

As will be recognized, in certain applications and/or systems, pressure limits on downstream flow (for example, license pressure of a well or wells) may exist or may be desirable. In such applications and/or systems, it downstream pressure may be monitored by one or more pressure sensors, and the adjustable passive choke devices as described herein may be operated to regulate or control pressure, or flow rate and pressure, as desired for the particular application. By way of example, in certain embodiments, an adjustable passive choke device as described herein may be used to reduce flow rate to one or more destinations, thereby reducing the pressure at the one or more destinations so as to maintain said pressure within a particular range, or below a particular upper limit, for example. Thus, it will be understood that adjustable passive choke devices as described herein may be for controlling fluid flow rate, for controlling downstream pressure, or both fluid flow rate and downstream pressure.

As will be understood, in certain embodiments, adjustable passive choke devices as described herein may be amendable to automation, thereby allowing for ongoing control of fluid flow rate and/or pressure. In an embodiment, fluid flow through the selectable bypass line of the adjustable passive choke device may be controlled by a programmable logic controller (PLC), or another computer-based controller. Such PLCs or other computer-based controllers may include a memory on which executable instructions for operation of the adjustable passive choke device may be stored. The executable instructions may be executed by a processor or microcontroller of the PLC in order to configure the PLC or other computer-based controllers to provide control of the adjustable passive choke device(s). The PLC may be implemented in various ways including as, for example, an application-specific integrated circuit (ASIC) or a field programmable gate array (FPGA), or other implementation combining a processing unit and memory. The PLC may receive input from one or more flow sensors monitoring a flow rate and/or other characteristics, and may control the fluid flow through the selectable bypass line or lines of the adjustable passive choke device(s) according to control logic to, for example, maintain a measured flow rate, a measured downstream pressure, or both within a particular target range or target ranges. The PLC may provide one or more output signals for activating or deactiving valves that control the fluid flow within the bypass lines. In addition to the executable instructions, the memory may further store certain operational targets or other operational parameters such as, but not limited to, a predetermined target flow rate value, a predetermined target lower flow rate limit, a predetermined target upper flow rate limit, a predetermined target acceptable flow rate range, a predetermined target downstream pressure value, a predetermined target lower downstream pressure limit, a predetermined target upper downstream pressure limit, or a predetermined target acceptable downstream pressure range. In certain embodiments, one or more device characteristics such as flow resistance element properties (such as, for example, the flow resistance contribution provided by each portion or subset of the flow resistance element, the pressure drop across each portion or subset of the flow resistance element, the length of each portion or subset of the flow resistance element, etc. . . . ) may be stored on the memory portion and used in determining which selectable bypass line(s) to activate/deactivate to achieve or maintain a desired flow rate and/or pressure.

During operation, such automated adjustable passive choke devices may monitor flow rate and/or pressure on an ongoing basis, and adjust flow resistance provided by the adjustable passive choke device (via activation or deactivation of the selectable bypass line and/or selection of the fluid flow bypass path where more than one is provided by the selectable bypass line) as needed such that flow rate and/or pressure is maintained at a predetermined value, above a predetermined lower limit, below a predetermined upper limit, or within a predetermined range, for example. Such devices may, for example, include a PLC or other computer-based controller which electronically controls operation of valves within the device which function to activate or deactivate the selectable bypass line and/or select the fluid flow bypass path where more than one is provided by the selectable bypass line.

As will be understood, adjustable passive choke devices as described herein may include any of a variety of different configurations, and many modifications may be possible. By way of example, in certain embodiments devices may comprise two or more flow resistance elements. Such flow resistance elements may each provide the same, or different, resistance to fluid flow therethrough. Such devices may include a selectable bypass line which is operable to provide one or more fluid flow bypass paths bypassing all, or a portion, of the two or more flow resistance elements, or may include two or more individually selectable bypass lines which are each operable to provide different fluid flow bypass paths when activated, or both.

Adjustable passive choke devices as described herein may be useful in oilfield operations such as, but not limited to, enhanced oil recovery (EOR)-type operations, water injection into wells, or the like. By way of example, adjustable passive choke devices as described herein may be used for controlling fluid flow rate through an injection well in an oil recovery operation. It will be appreciated that, typically, fluid is supplied to such injection wells through a common line in communication with a fluid pump. It will be understood, however, that adjustable passive choke devices as described herein may be of use in a wide variety of suitable applications where adjustable control of flow rate is needed or desired, and are not limited to oilfield-type operations.

In another embodiment, there is provided herein a fluid transport system comprising:
one, two or more fluid distribution lines;
a common line for supplying a fluid to the one, two or more fluid distribution lines;
a pump for supplying the fluid to the common line; and
at least one adjustable passive choke device as described hereinabove positioned before or within at least one of the fluid distribution lines for controlling flow rate therethrough and/or pressure downstream thereof.

In certain further embodiments, operation of the one or more adjustable passive choke devices may be controlled by a programmable logic controller (PLC) or other computer-based controller as described hereinabove.

In still further embodiments, the one or more adjustable passive choke devices may control flow rate such that fluid flow rate through two or more fluid distribution lines is substantially equal, or such that fluid flow rate between the two or more fluid distribution lines is maintained at a predetermined ratio, above a predetermined lower ratio limit, below a predetermined upper ratio limit, or within a predetermined ratio range.

In even further embodiments, the one or more adjustable passive choke devices may adapt to changes in fluid flow resistance in the fluid distribution lines such that flow rate and/or pressure through the fluid distribution lines remains substantially constant, or within predetermined range(s).

As will be understood, in certain embodiments, the fluid distribution lines may be injection wells in an oil recovery operation, and the common line may be a supply line providing, for example, a polymer or other EOR fluid for downhole injection, or water for downhole injection, or the like. It will be understood, however, that such fluid transport systems as described herein may be of use in a wide variety of suitable applications where adjustable control of flow rate is needed or desired, and are not limited to oilfield-type operations.

In still another embodiment, there is provided herein a method for controlling a flow rate and/or pressure of a fluid through a fluid distribution line, said method comprising:
reducing the fluid flow rate by passing the fluid through a flow resistance element; and
increasing the fluid flow rate by passing the fluid through a fluid flow bypass path which bypasses all, or a portion, of the flow resistance element;

as needed so as to maintain the flow rate, the pressure, or both, of the fluid through the fluid distribution line at predetermined value(s), above predetermined lower limit(s), below predetermined upper limit(s), or within predetermined range(s).

In certain embodiments, such methods may be performed by operating an adjustable passive choke device as described hereinabove. In certain further embodiments, the method may be an automated method performed by a programmable logic controller (PLC) or other computer-based controller as described hereinabove.

### Example 1—Automated Adjustable Passive Choke Device and System

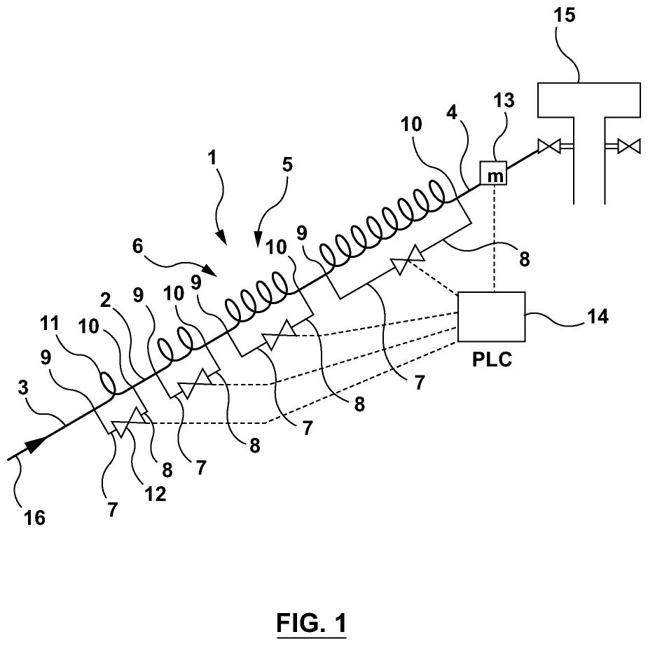

An example of an adjustable passive choke device for controlling fluid flow rate, downstream pressure, or both, is described in further detail below with reference to FIG. 1. This FIGURE depicts an example of an adjustable passive choke device (1) which is installed at an injection well (15) in an oil recovery operation.

The adjustable passive choke device (1) of FIG. 1 is for controlling fluid flow rate and/or pressure through the injection well (15). The device (1) includes a fluid conduit (2) in the form of a pipe having a first end (3), a second end (4), and an intervening portion (5) therebetween. The intervening portion (5) comprises a flow resistance element (6) for reducing a flow rate of a fluid when the fluid is passed through the fluid conduit (2) from the first end (3) to the second end (4). The flow resistance element (6) in this example is a coil choke-type resistance element comprising a plurality of loops or coils (11) for reducing fluid flow rate by frictional line loss.

The adjustable passive choke device of FIG. 1 further includes a plurality of selectable bypass lines (7) connected upstream (at upstream connections (9)) and downstream (at downstream connections (10)) of various portions of the flow resistance element (6). In the illustrated example, the flow resistance element (6) includes a 1-loop section, a 2-loop section, a 4-loop section, and an 8-loop section connected in series, each having a selectable bypass line (7) associated therewith. Each selectable bypass line (7) is operable to provide a fluid flow bypass path (8) bypassing a corresponding section of the flow resistance element (6) when activated. As such, the illustrated adjustable passive choke device (1) may be configured to flow fluid through 0, 1, 2, 3, 4, 5, 6, 7, 8, 9, 10, 11, 12, 13, 14, or 15 loops (11), depending on the flow resistance desired, by selecting the appropriate combination of activated/deactivated selectable bypass lines (7). Even further adjustment over flow resistance may be possible by partially activating one or more of the selectable bypass lines (7) to allow a portion, but not all, of the fluid to bypass the associated resistance element loop(s). In the device (1) illustrated in FIG. 1, fluid flow through the selectable bypass lines is controlled by one or more valves (12). In this example, the valves (12) are automated solenoid valves.

The device illustrated in FIG. 1 further comprises a flow meter (13) downstream of the flow resistance element (6) for determining fluid flow rate. The illustrated device may also optionally include one or more pressure gauges (not shown) and/or other sensors for determining pressure drop across the coils (i.e. (Δ pressure)/(length)) and/or for determining downstream pressure. Such pressure drop across the coils and/or downstream pressure may optionally be determined and/or monitored on an ongoing basis, and may each be used as parameter(s) when determining activation/deactivation of the selectable bypass line(s) of the adjustable passive choke device so as to maintain a desired flow rate and/or pressure in the system. The person of skill in the art having regard to the teachings herein will be able to select the number and location of such optional pressure gauges and/or other sensors so as to provide pressure information suitable for a particular application.

In FIG. 1, fluid flow through the selectable bypass lines (7) is controlled by a programmable logic controller (PLC) (14). Activation and deactivation of the selectable bypass lines (7), and selection of active fluid flow bypass paths (8) is automated, such that flow rate, downstream pressure, or both, is maintained at predetermined value(s), above predetermined lower limit(s), below predetermined upper limit(s), or within predetermined range(s).

The device (1) illustrated in FIG. 1, which is installed at an injection well (15) in an oil recovery operation, and which is supplied with fluid by a common supply line (16), also provides an example of a fluid transport system as described herein.

Such a system may comprise two or more fluid distribution lines (i.e. injection wells (15)), a common line (16) for supplying a fluid to the two or more fluid distribution lines (15); and at least one adjustable passive choke device (1) positioned before or within at least one of the fluid distribution lines (15) for controlling flow rate therethrough. While FIG. 1 depicts a single injection well (15), a second injection well (15) supplied by common line (16) may be located downstream of the portion of the system shown in FIG. 1, for example.

In the illustrated system, a pump (not shown) is used for supplying the fluid to the common line (16). Although a pump is being used in the illustrated system for supplying the fluid to the common line (16), and flowing the fluid through the common line (16) to the injection wells (15), it will be understood that other suitable apparatus may also be used for supplying and/or flowing the fluid through the system.

In the illustrated embodiment in FIG. 1, operation of the adjustable passive choke device (1) is controlled by a programmable logic controller (PLC) (14) such that adjustable passive choke device (1) controls flow rate such that fluid flow rate through the two fluid distribution lines (i.e. injection wells (15)) is substantially equal, or such that fluid flow rate between the two or more fluid distribution lines (15) is maintained at a predetermined ratio, above a predetermined lower ratio limit, below a predetermined upper ratio limit, or within a predetermined ratio range. In the illustrated embodiment, the automated adjustable passive choke device (1) adapts to changes in fluid flow resistance in the fluid distribution lines (15) such that flow rate and/or pressure through the fluid distribution lines (15) remains substantially constant, or within predetermined range(s).

One or more illustrative embodiments have been described by way of example. It will be understood to persons skilled in the art that a number of variations and modifications can be made without departing from the scope of the invention as defined in the claims.

1.-24. (canceled)

25. An adjustable passive choke device for controlling fluid flow rate, pressure, or both, said device comprising:
a fluid conduit having a first end, a second end, and an intervening portion therebetween, the intervening portion comprising a flow resistance element for reducing a flow rate of a fluid when the fluid is passed through the fluid conduit from the first end to the second end; and
a selectable bypass line connected upstream and downstream of the flow resistance element, or a portion thereof, operable to provide a fluid flow bypass path bypassing all, or a portion, of the flow resistance element when activated;
whereby activation of the selectable bypass line configures the adjustable passive choke device for increased flow rate by at least partially opening the fluid flow bypass path, and deactivation of the selectable bypass line configures the adjustable passive choke device for decreased flow rate by at least partially closing the fluid flow bypass path.

26. The device of claim 25, further comprising a flow meter downstream of the flow resistance element for determining a fluid flow rate, a pressure gauge or pressure sensor for determining a pressure downstream of the flow resistance element, or both.

27. The device of claim 25, wherein the selectable bypass line comprises two or more upstream connections, downstream connections, or both, so as to provide a plurality of selectable fluid flow bypass paths, each bypassing a different proportion of the flow resistance element.

28. The device of claim 25, wherein the flow resistance element comprises one or more loops or coils for reducing fluid flow rate by frictional line loss.

29. The device of claim 25, wherein fluid flow through the selectable bypass line is controlled by one or more valves.

30. The device of claim 25, wherein the device further comprises one or more pressure gauges or pressure sensors for determining a pressure drop (Δ pressure/length) across the flow resistance element or one or more portions thereof.

31. The device of claim 25, wherein fluid flow through the selectable bypass line is controlled by a programmable logic controller (PLC).

32. The device of claim 25, wherein activation and deactivation of the selectable bypass line, and selection of the fluid flow bypass path where the selectable bypass line includes more than one fluid flow bypass path, is automated, such that flow rate, downstream pressure, or both, is maintained at predetermined value(s), above predetermined lower limit(s), below predetermined upper limit(s), or within predetermined range(s).

33. The device of claim 32, wherein activation and deactivation of the selectable bypass line, and selection of the fluid flow bypass path where the selectable bypass line includes more than one fluid flow bypass path, is determined at least in part by a measured flow rate parameter, a measured pressure drop parameter, a measured downstream pressure parameter, or both.

34. The device of claim 25, wherein the device comprises two or more flow resistance elements.

35. The device of claim 34, wherein the flow resistance elements may each provide the same, or different, resistance to fluid flow therethrough.

36. The device of claim 33, wherein the selectable bypass line is operable to provide one or more fluid flow bypass paths bypassing all, or a portion, of the two or more flow resistance elements.

37. The device of claim 25, wherein the device comprises two or more individually selectable bypass lines which are each operable to provide different fluid flow bypass paths when activated.

38. The device of claim 25, wherein the adjustable passive choke device is for controlling flow rate and/or pressure through an injection well in an oil recovery operation, or through an industrial water injection operation.

39. The device of claim 25, wherein the flow resistance element is structured with a 2× multiplier configuration providing incremental doubling of length and/or flow resistance between portions of the flow resistance element.

40. A fluid transport system comprising:
one, two or more fluid distribution lines;
a common line for supplying a fluid to the one two or more fluid distribution lines;
a pump for supplying the fluid to the common line,
at least one adjustable passive choke device according to claim 25 positioned before or within at least one of the fluid distribution lines for controlling flow rate therethrough and/or pressure downstream thereof, and, optionally,
operation of the one or more adjustable passive choke devices are controlled by a programmable logic controller (PLC).

41. The system of claim 40, wherein the one or more adjustable passive choke devices control flow rate such that fluid flow rate through two or more of the fluid distribution lines is substantially equal, or such that fluid flow rate between the two or more fluid distribution lines is maintained at a predetermined ratio, above a predetermined lower ratio limit, below a predetermined upper ratio limit, or within a predetermined ratio range.

42. The system of claim 41, wherein the one or more adjustable passive choke devices adapt to changes in fluid flow resistance in the fluid distribution lines such that flow rate and/or pressure through the fluid distribution lines remains substantially constant or within predetermined range(s).

43. The system of claim 40, wherein the fluid distribution lines are injection wells in an oil recovery operation, or in a water injection operation.

44. A method for controlling a flow rate and/or pressure of a fluid through a fluid distribution line, said method comprising:
reducing the fluid flow rate by passing the fluid through a flow resistance element; and
increasing the fluid flow rate by passing the fluid through a fluid flow bypass path which bypasses all, or a portion, of the flow resistance element;
as needed so as to maintain the flow rate, the pressure, or both, of the fluid through the fluid distribution line at predetermined value(s), above predetermined lower limit(s), below predetermined upper limit(s), or within predetermined range(s),
wherein the fluid distribution line is an injection well of an oil recovery operation, or of a water injection operation, and
wherein optionally the method is an automated method performed by a programmable logic controller (PLC).
